(19) United States
(12) Patent Application Publication
(10) Pub. No.: US 2014/0039995 A1
(43) Pub. Date: Feb. 6, 2014

(54) System and Method of Customer Acquisition Leveraging Social Media and Automating Billing Reflecting Rewards for Customer Acquisition

(71) Applicants: Timothy Ngo, Austin, TX (US); Sean Wade, Houston, TX (US)

(72) Inventors: Timothy Ngo, Austin, TX (US); Sean Wade, Houston, TX (US)

(21) Appl. No.: 13/957,422

(22) Filed: Aug. 1, 2013

Related U.S. Application Data
(60) Provisional application No. 61/678,224, filed on Aug. 1, 2012.

(51) Int. Cl. G06Q 30/02; G06Q 50/00

(52) U.S. Cl. CPC G06Q 30/0214; G06Q 50/01
USPC 705/14.16

(57) ABSTRACT

A system and method of acquiring new customer is provided. A first user activates a UI component such that a custom-created content is disseminated to a social media platform. The custom-created content contains content referring a featured service of a service provider and a referral instrument. A second user activates the referral instrument via the social media platform. The activation directs the second user to initiate a sign-up process with a backend system of the service provider and enables the backend system to capture information identifying the first user as a referrer at the start of the referee's sign-up process. The backend system provides referral credits to the first user following the signing-up of the second user. A billing module of the backend system automatically generates a bill for the second user reflecting referral credits awarded to the first user for the referral of the second user.

### CROSS-REFERENCE TO RELATED APPLICATION

This application claims the benefit under 35 U.S.C. §119(e) of Provisional Patent Application No. 61/678,224, filed Aug. 1, 2012, the entire disclosure of which is hereby incorporated by reference.

### BACKGROUND

1. Technical Field

The present disclosure generally relates to a system and method of customer acquisition and retaining. The present disclosure more particularly relates to a system and method of customer acquisition that leverages social media and automates a billing process which generates bills reflecting rewards provided to a user for the user's social media activities resulting in customer acquisition.

2. Description of the Related Art

Service providers typically spend a significant percentage of their revenues to acquire new customers and maintaining existing customers. Taking cellular service providers as an example, a national or regional cellular service provider typically spends money to set up local stores and pay store employees to acquire new cellular subscribers. The service provider may have to subsidize new cellular phone purchase in order to acquire new subscribers. The service provider may also need to spend large sums of money to advertise its services through TV, radio and/or Internet advertisements. Besides, the service provider may need to maintain a call center to answer questions of existing customer in order to providing support to existing customers. For various service providers, these types of customer acquisition expenses can constitute a significant percentage of their respective revenues, and can erode their profitability.

Therefore, new innovative systems and methods for acquiring new customers that can help eliminate or reduce conventional expenses associated therewith are always needed.

### BRIEF SUMMARY

In one aspect, the present disclosure provides a system and method that enables and/or facilitates a user to use social media to refer “friends” of the user to a service provider with which the user is registered. In particular, the disclosed system provides one or more GUI components adapted to enable the user to provide a social media content custom created to refer a featured service of the service provider to “friends” of the user as well as facilitate the capturing of the referral provided by the user in the event that a friend of the user uses the custom created content to sign up with the service provider. The social media content may include text and/or multimedia content referring the featured service as well as a referral instrument configured to direct a referee to initiate a sign-up process with the backend system of the service provider when activated by the referee and enable the backend system to capture information identifying the referrer (which, in this case, is the user) at the start of the referee's sign-up process so that the backend system may use the captured referrer information to appropriately reward the referrer for the signing-up of the referee. In one embodiment, the referral instrument is provided in the form of a clickable hyperlink pointing to a URL containing an identifier indicating a registration function as well as an identifier identifying the referrer. The activation of the referral instrument is through clicking of the hyperlink. Thus, the capturing of the referrer's effective referral of the referee to the service provider (that results in the referee signing up with the service provider) becomes automated and hassle-free.

In another aspect, the present disclosure provides a system and method that automates a billing process in which a billing module of a backend system (of a service provider) automatically and timely generates a bill (for a user) reflecting rewarding of a user for the user's effective customer acquisition accomplishments. In one implementation, the billing module retrieves referral data of the user relating to registered customer and non-customer users that are referred to the service provider by the user, and calculates rewards for the user based on the retrieved referral data of the user. In one embodiment, the rewards are provided in the form of credits. The billing module then generates a final bill for the user by subtracting the calculated credit amount from an otherwise owed total bill. As such, the user's effective customer acquisition accomplishments are automatically and timely reflected in the user's recurring or non-recurring bills, thus motivating the user to continue to engage in customer acquisition activities.

In still another aspect, the present disclosure provides a system and method that combines and integrates the aforementioned aspect of leveraging social media to facilitate a user to acquire new customers with the aforementioned aspect of automating billing reflecting rewards for customer acquisition to motivate a user to engage in customer acquisition activities. This combination and integration effectively increase the efficiency of using existing registered users to acquire new customers, thereby helping a service provider to effectively reduce cost which otherwise would be forced to incur in expanding and growing the service provider's underlying business.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements may be exaggerated relative to other elements. Embodiments incorporating teachings of the present disclosure are shown and described with respect to the figures presented herein, in which:

FIG. 1 is a general diagram illustrating an exemplary environment of the disclosed system and method, according to one or more embodiments of the present disclosure.

FIG. 2 is a block diagram illustrating backend system 102, according to one or more embodiments of the present disclosure.

FIG. 3 a flowchart exemplifying a process leveraging social media and automating billing, as employed by the disclosed system to realize customer acquisition, according to one or more embodiments of the present disclosure.

FIGS. 4A-G are pictorials illustrating exemplary UIs provided in connection with blocks exemplified in FIG. 3, according to one or more embodiments of the present disclosure.

FIG. 5 is a flowchart illustrating an exemplary implementation of block 304 exemplified in FIG. 3, according to one or more embodiments of the present disclosure.

FIG. 6 is a flowchart illustrating an exemplary implementation of block 305 exemplified in FIG. 3, according to one or more embodiments of the present disclosure.

FIG. 7 is a flowchart illustrating an exemplary implementation of block 306 exemplified in FIG. 3, according to one or more embodiments of the present disclosure.

### DETAILED DESCRIPTION

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. The following detailed description is, therefore, not to be taken in a limiting sense, and the scope of the present disclosure is defined by the appended claims and equivalents thereof.

References within the specification to “one embodiment,” “an embodiment,” “embodiments”, and “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

The terminology used herein is for the purpose of describing particular embodiments only and is not intended to be limiting of the disclosure. As used herein, the singular forms “a”, “an” and “the” are intended to include the plural forms as well, “or” includes “and/or,” and reference to a numerical value includes at least that value, unless the context clearly indicates otherwise. Moreover, the use of the terms first, second, etc. do not denote any order or importance, but rather the terms first, second, etc. are used to distinguish one element from another.

Functional steps illustrated herein, unless otherwise specified as, or logically required to be, performed in accordance with a specific sequence, are presumed to be performable in any order without regard to a specific sequence.

Within the descriptions of the different views of the figures, the use of the same reference numerals and/or symbols in different drawings indicates similar or identical items, and similar elements can be provided similar names and reference numerals throughout the figures. If a reference numeral is once used to refer to a plurality of like elements, unless required otherwise by context, the reference numeral may refer to any, a subset of, or all of, the like elements in the figures bearing that reference numeral. The specific identifiers/names and reference numerals assigned to the elements are provided solely to aid in the description and are not meant to imply any limitations (structural or functional or otherwise) on the described embodiments.

In the description, relative terms such as “left,” “right,” “vertical,” “horizontal,” “upper,” “lower,” “top” and “bottom” as well as any derivatives thereof should be construed to refer to the logical orientation as then described or as shown in the drawing figure under discussion. These relative terms are for convenience of description and are not intended to convey any limitation with regard to a particular orientation.

In the present disclosure, the terms “module”, “sub-module”, “application”, “application module”, “software”, “software program”, “software module”, “programmatic module”, “code”, “application code”, “programmatic code”, “object”, “programmatic object”, “script”, “routine”, “service routine”, “function”, “service”, “engine”, “processor”, “component”, and so on, when context allows, may be used interchangeably to refer to one or more sets of computer instructions adapted to perform, when executed by a processor (such as a microprocessor or a microcontroller), one or more specific functions.

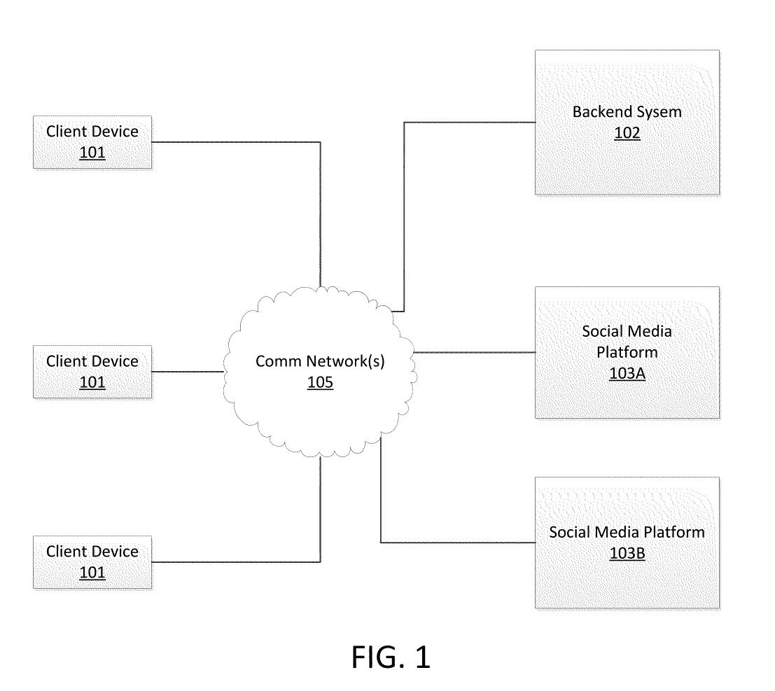

With reference now to the figures, and beginning with FIG. 1, there is depicted a general diagram illustrating an exemplary environment of a disclosed system and method, according to one or more embodiments of the present disclosure. Referring to FIG. 1, each of backend system 102 and social media platforms 103 (such as social media platforms 103A and 103B) are communicatively coupled to a plurality of network-capable client devices 101 through one or more communication networks 105, which may include Internet and/or one or more interconnected networks, such as one or more cellular networks, or one or more local area networks.

Backend system 102 may be used to implement the disclosed system and method of customer acquisition. From a business standpoint, backend system 102 may be used by a service provider to acquire new customers who use or subscribe one or more revenue-generating featured services provided by the service provider (hereinafter simply referred to as “the featured service”). In the present disclosure, the term “backend system”, depending on the context in which the term is used, may also refer to the aforementioned service provider. For ease of discussion, from now on, the present disclosure will use cellular service as the primary example a revenue-generating service provided by the service provider for which the service provider uses the disclosed system and method to acquire new customers. A skilled artisan would readily appreciate that the disclosed system and method may be applicable to any revenue-generating services provided by any service providers, and thus may be used by any service provider who provides one or more revenue-generating services to the public.

As shown, backend system 102 is communicatively is coupled to social media platforms 103 (such as social media platforms 103A and 103B) via communication networks 105. For the present disclosure, the term “social media” and the term “social media platforms” shall be construed broadly. More specifically, the term “social media” may generally refer to any media designed to be disseminated through social interactions. In particular, social media may take on various forms, including, but not limited to social networks, e-mails, tweets, instant messaging, Internet discussion forums, blogs, wiki postings, podcasts, and the like. The term “social media platforms” may generally refer to any electronically communicable platform (such as a web site and/or a software program) which realizes any of disseminating, exchanging and sharing social media between users. Examples of social media platforms may include web sites (such as Facebook, Google Plus, LinkedIn, Tweeter and Tumblr), e-mail applications (such as GMAIL and Yahoo! Mail), instant messaging software programs (such as Skype and MSN Live), Messaging services (such as SMS and Tweeter), and so on.

A user may use one or more client devices 101 to join any social media platform 103 and perform social media activities through one or more social media platforms 103. Social media activities performed may include sending and receiving e-mails, sending and receiving text messages, tweeting, posting photos and videos, posting status updates, posting comments to other user's postings of images and updates, tagging users into pictures, blogging, instant messaging, and so on.

A client device 101 can be any computing device having networking capabilities and loaded with one or more client applications enabling a user to perform social media activities. Examples of a client device 101 may include a smart phone, a PC, a notebook computer, a tablet and a PDA. Applications running on a client device 101 are commonly referred to as “apps” when the client device is a smart mobile device such as a smart phone or a tablet PC. As used herein, the term “client application” refers to a software application running on a client device 101.

Client applications may include a web browser, which renders HTML pages received from backend system 102 or a social media platform 103. Additionally and/or alternately, client applications may include one or more custom applications. The one or more custom applications, in lieu of or in addition to a web browser, are specifically programmed to provide custom graphical user interfaces (GUIs) that enables the user to, for example, exchange or display information with a specific backend server, such as server 201 of backend system 102 or a backend server of a social media platform 103. A custom application may exist in various forms. For example, a custom application may be a standalone application running in a smart phone, a tablet, PC or notebook computer. A custom application may also be a software module running inside a specific application context, such as a so-called “Facebook app” running inside a Facebook context (a social networking context), or either a Java applet or an ActiveX control running inside a browser.

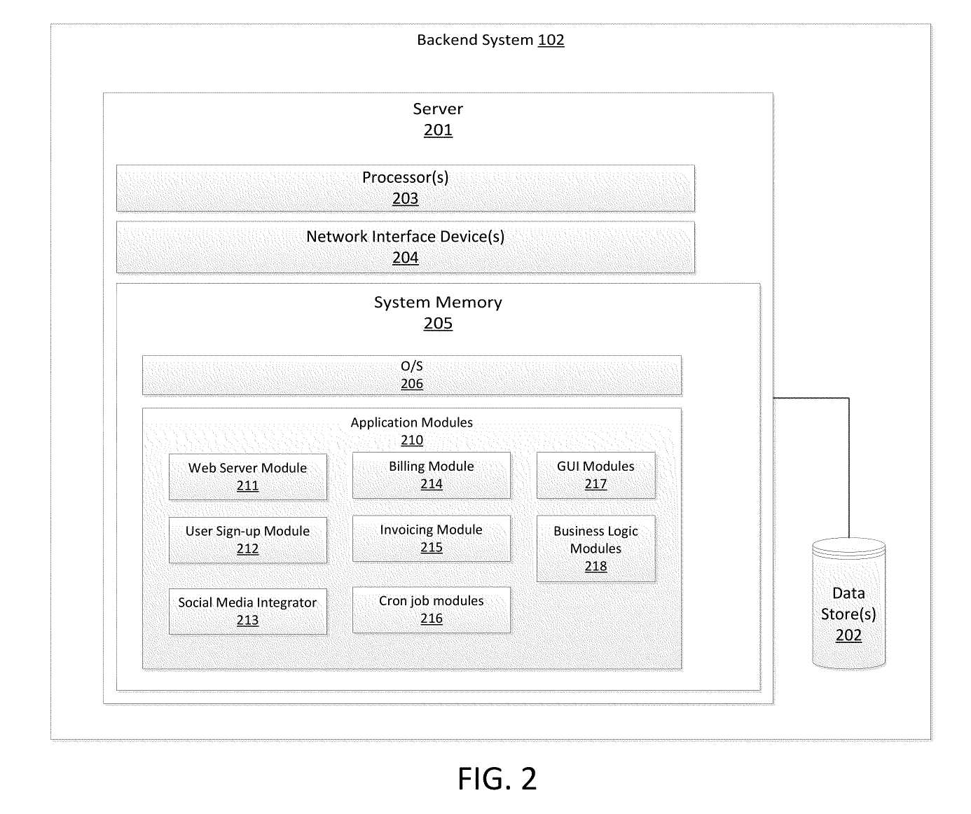

FIG. 2 is a block diagram illustrating backend system 102 according to one or more embodiments of the present disclosure. Referring to FIG. 2, backend system 102 may comprise server 201 and data store 202. As used herein, the term “server” refers to any of various types of computing devices, such as computer clusters, server pools, general-purpose personal computers, workstations, or laptops. Server 201 comprises, inter alia, one or more processors 203 (such as one or more microprocessors), one or more network interface devices 204, and one or more system memories 205. During an operation of server 201, software modules or firmware modules, such as operating system 206 and a plurality of application modules 210, are loaded into system memories 308. These software or firmware modules, when executed by processor 203, are adapted to perform various functions for which their respective programmatic (software) codes are programmed.

Data store 202 (hereinafter referred to as “DS 302”) is communicatively coupled to server 301. DS 202 may exist or be implemented in one or more of various forms, such as one or more local or distributed relational or objective databases, one or more local or distributed file systems, one or more removable storages, one or more memory caches, one or more memory clusters, or any combination thereof. In one embodiment, DS 202 resides in server 201. In another embodiment, DS 202 resides external to server 201. DS 202 may be configured to store information of users associated with the service provider. For example, DS 202 may establish an account for a user (which may be a customer user and a non-customer “ambassador” only user), and store account information of the user, such as profile information of the user. DS 202 may store information about social media activities which a user has performed in furtherance of the objective of attracting and/or recruiting a potential new customer for the service provider. If the user is a customer user of the service provider, then DS 202 may also store billing information and payment information of the user. For the present disclosure, the term “customer” and the term “customer user” may be used interchangeably.

Application modules 210 may be implemented in various forms, such as standalone executable programs, callable functions and routines, scripts that can be executed via running of one or more interpreter programs, services that may be invoked by standard or proprietary protocols, and programmatic objects containing both data and callable functions. In one embodiment, application modules 210 may include web server module 211, user sign-up module 212, social media integrator module 213, billing module 214, invoicing module 215, cron job modules 216, graphical user interface (GUI) modules 217, and business logic modules 218.

Web server module 211 may be programmed and configured to receive web requests from a client application (such as a web browser) of a client device 101 and delivers a corresponding web response to a client application. User sign-up module 212 may be programmed and configured to process a sign-up request of a user. Social media integrator module 213 may be programmed and configured to interface with one or more social media platforms 103 via, e.g., calling APIs provided the one or more social media platforms 103 through respective tokens provided by the one or more social media platforms 103, such that social media content (such as text, audio and/or video) created to refer one or more features services of the service provider and direct a referee to sign up with the service provider is disseminated to “friends” or “followers” of a user (on behalf of the user) through the interfaced one or more social media platforms 103.

Billing module 214 may be programmed and configured to bill users for the users' use, subscription, and/or affiliation of the featured service provided by the service provider. Typically, a customer user is billed based on one or more parameters associated with the use or subscription of the featured service. For example, if the service provider provides cellular service to customer users, the service provider may bill a customer user based on air time of the customer, the rate plan which the customer is subscribed to, third-party services which the user has consumed, and so on. As used herein, the term “billing” shall be construed broadly to also include crediting a registered user cash or non-cash benefits for customer acquisition activities and/or achievements which the user has performed or attained to bring benefits to the service provider. Billing module 214 may be a standalone commercial-off-the-shelf software program. Billing module 214 may additionally or alternately be a callable function or a callable module including a set of callable functions. DS 202 may be used to store billing information of users. Thus, in performing billing service, billing module 214 may access DS 202 to obtain users' billing information stored therein and perform billing service based on obtained billing information. Additionally, if billing module 214 is a standalone commercial-off-the-shelf software program, billing module 214 may be configured and customized (through, e.g. custom programmed software adaptors to the billing module 214) to suit the service provider's billing needs.

Invoicing module 215 may be programmed and configured to perform regular invoicing services. Invoicing module 215 may be a standalone commercial-off-the-shelf software program, or additionally or alternately a callable function or a callable module including a set of callable functions. Cron job modules 216 may be programmed and configured to execute pre-defined (re-programmed) cron jobs (which may be pre-scheduled or on-demand). Examples of those cron jobs may include daily billing cron jobs, daily auto-bill-pay cron jobs and daily invoice notification cron jobs.

GUI modules 217 may be programmed and configured to generate specific UI instructions (which may include both presentation semantics and data to be displayed). Typically, these UI instructions would be subsequently provided to a client application by backend system 102 (through, for example, web server module 211) via one or more communication channels between the client device 101 hosting the client application and backend system 102. Thus, for illustration and not limitation, one or more GUI modules 217 may generate UI instructions to render one or more UIs to enable a user to sign up with backend system 102, to log into backend system 102, to refer a friend or an acquaintance to the service provider through one or more social media platforms 103, to view a recent monthly bill, to view information about basis of the recently monthly bill, and so on. GUI modules 217 may not be needed if a client application used to display UIs for the disclosed system and method is not a browser, but rather an “app” (or, in other words, a custom application) specifically programmed and configured to work in concert with backend system 102 in regard to UI displays.

Business logic modules 218 may be programmed and configured to implement business logics and functionalities needed by one or more other application modules 210. For example, business logic modules 218 may be programmed and configured to retrieve from DS 202 account data of a specific user, or to store newly generated or submitted account data (such as payment data) into the user' account in DS 202, as requested by one or more other application modules 210.

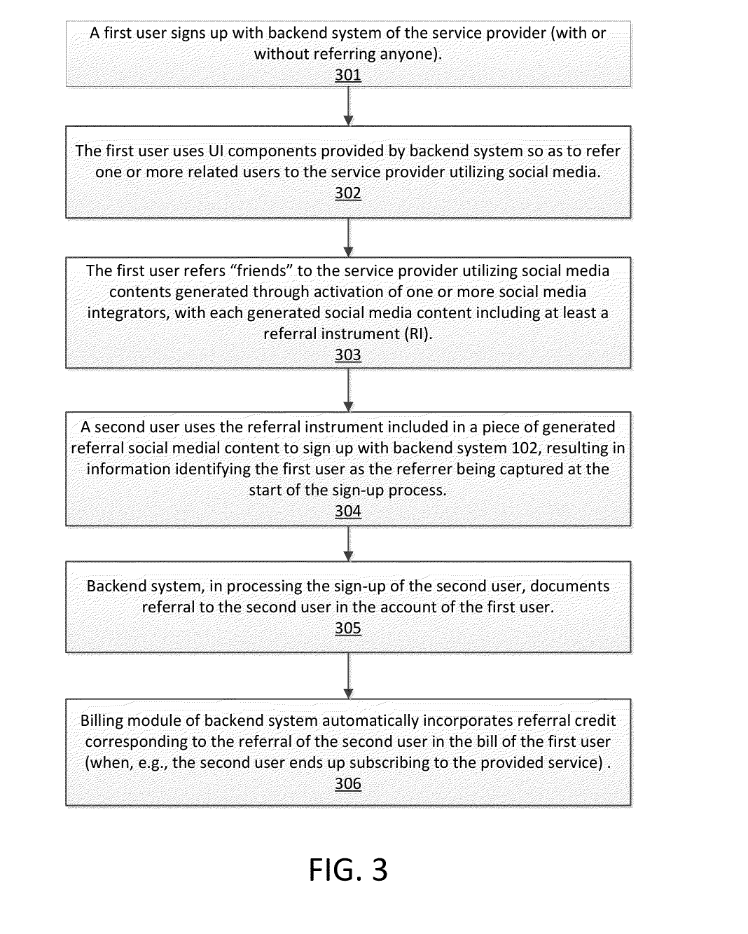

FIG. 3 is a flowchart exemplifying a process (as used by the disclosed system and method) through which customer acquisition is realized, according to one or more embodiments of the present disclosure. In one embodiment, the exemplified process leverages social media so as to greatly facilitate acquisition of a new customer, and automates a billing process that generates bills reflecting rewards provided to a user for the user's customer acquisition achievements. As used herein, the terms “block” and “step” may be used interchangeably to refer to a set of programmatic code adapted to perform one or more specific functions when executed by processor 203.

At block 301, a first user signs up (or, in other words, registers) with backend system 102. In particular, the user does not necessarily sign up as a customer of the service provider (operating backend system 102). The first user may sign up as an “ambassador” of the service provider for the sole purpose of helping the service provider to attract, recruit, and/or acquire new ambassador users or customer users. The first user may additionally or alternately sign up as a customer of the service provider for the featured service of the service provider.

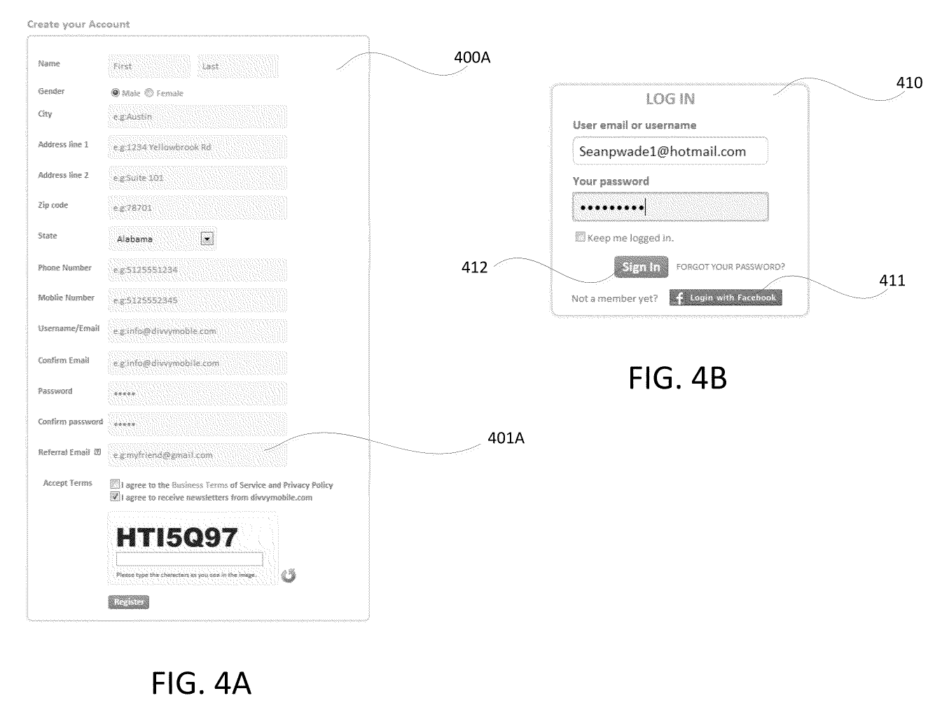

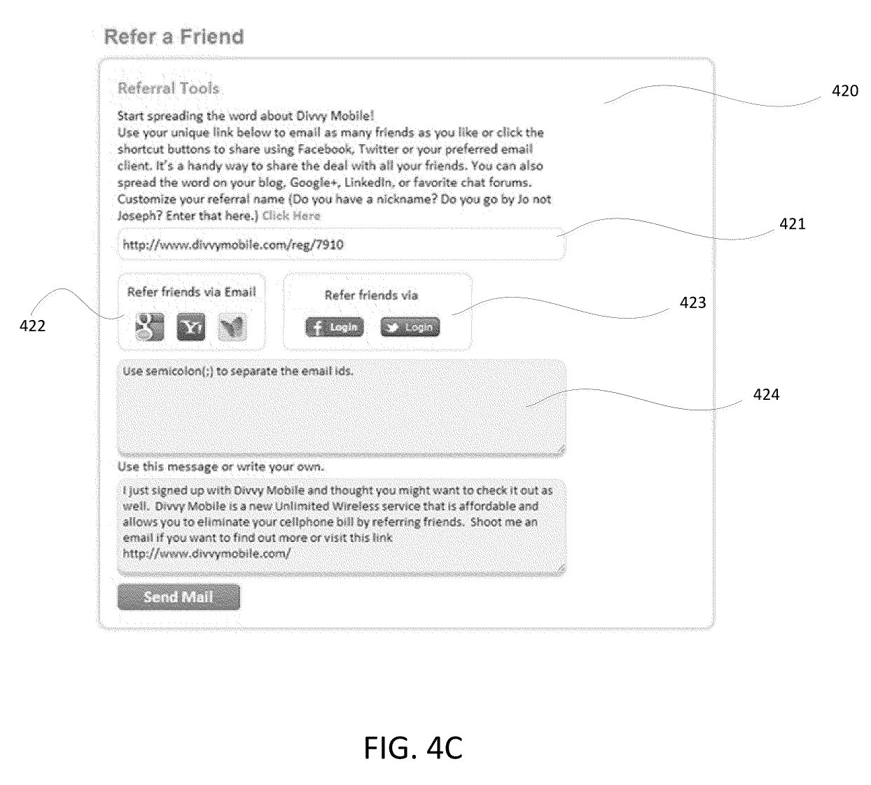

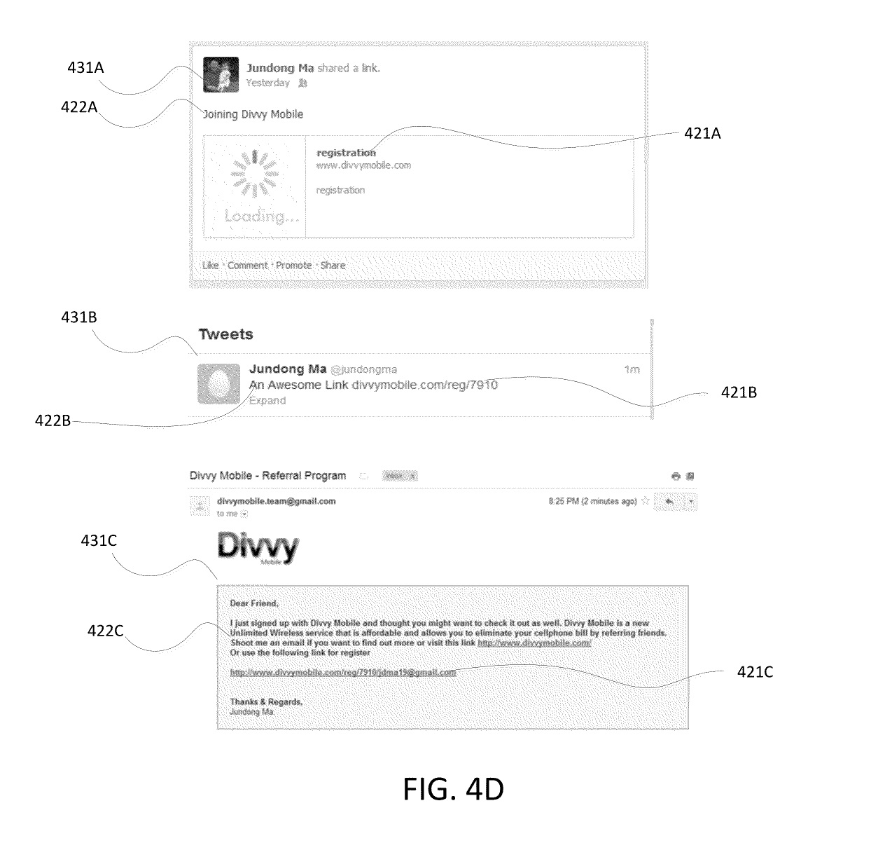

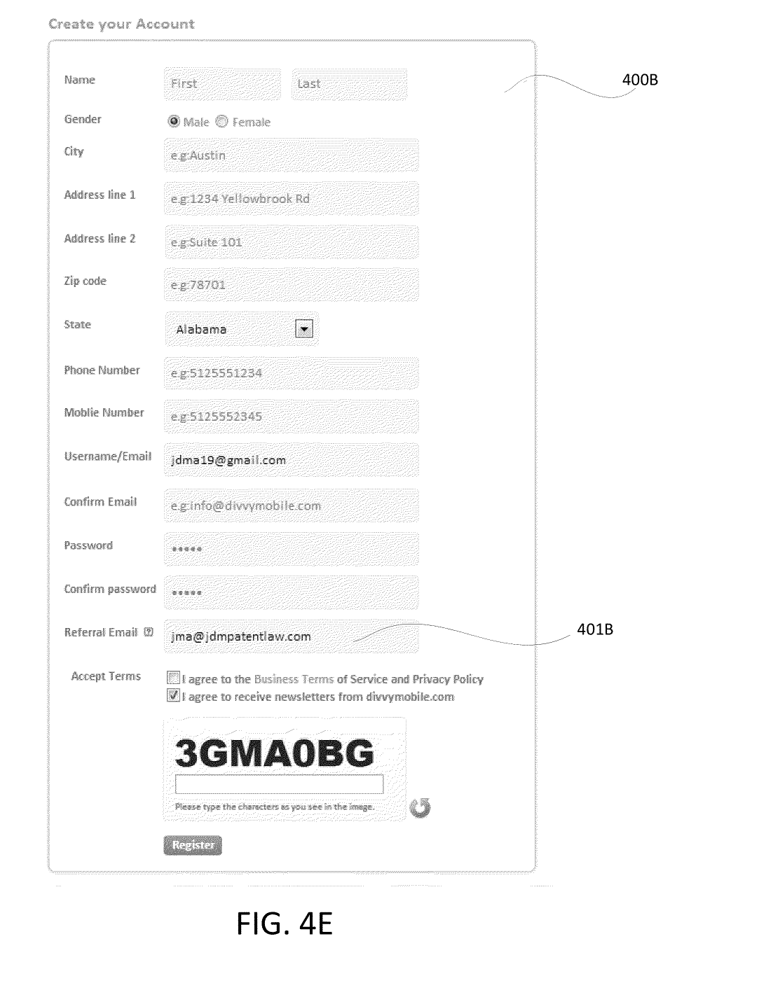

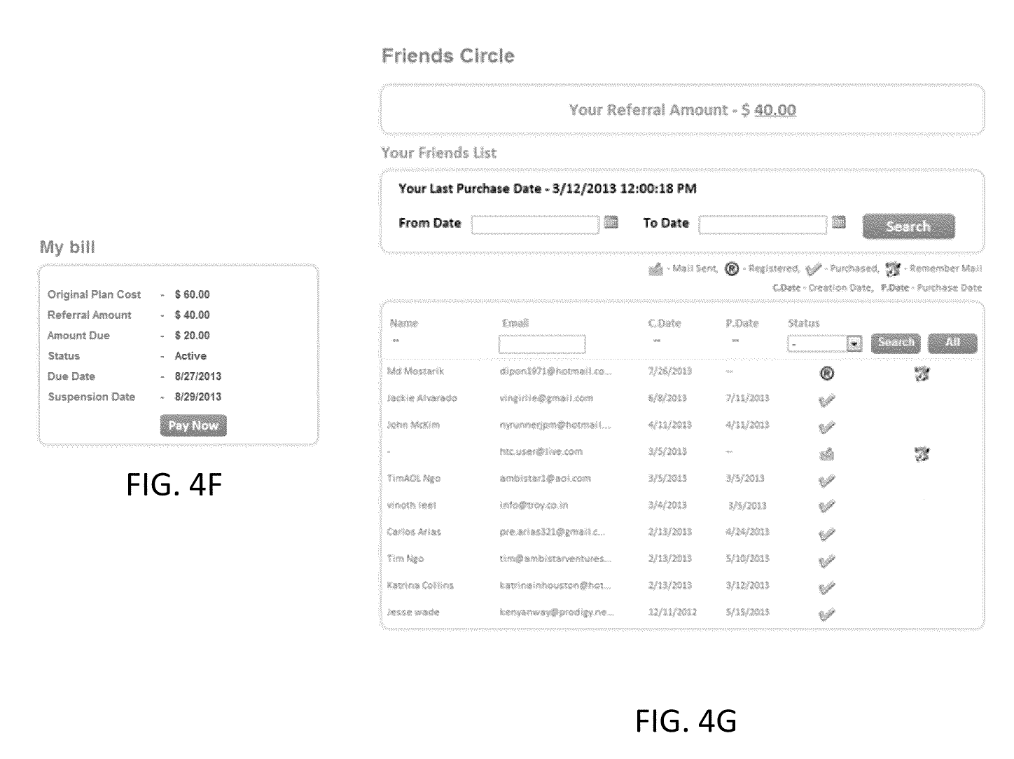

FIG. 4A is a pictorial illustrating an exemplary sign-up form 400A, according to one or more embodiments of the present disclosure. Sign-up form 400A includes fields which are common for most sign-up forms, such as name, gender, address, phone number, e-mail (used as a user name), password, confirmation of password, one or more check boxes for terms and conditions, and a CAPTCHA entry (for defending or preventing “bots” from hacking the backend system). Additionally, sign-up form 400A also includes a “referral” field 401A (such as an e-mail address) that lets the first user to identify a person who refers the first user to the service provider. This “referral” field may be left empty if the first user's decision to sign-up with the service provider is not due to a referral from another person. This “referral” field, however, plays a role in enabling and/or facilitating an automated capturing of referrer information that can be used to reward a referrer, as will be further explained below when discussing block 305.

After the first user completes the form (by filling in the fields which are required for a successful registration) and clicks the “Register” button in sign-up form 400A, the completed form is submitted to server 201 of backend system 102. To server 201, submitting the completed sign-up form represents a request for signing up with backend system 102. Thus, upon receiving the form data of the completed sign-up form (via, e.g. web server module 211), server 201 may perform routine processing for a sign-up request (via, e.g. user sign-up module 212). The routine sign-up processing may include establishing an account for the first user, assigning an internally generated identifier to uniquely identify the first user (as well as the newly established account), and storing received form data as well as the generated internal identifier in DS 202 under the newly established account for the first user.

In one embodiment, the first user signs up as a customer of the service provider. Thus, besides using sign-up form 400A to sign up with the service provider, the first user may also need to go through additional steps (not shown) relating to using or subscribing to a service provided by the service provider. For example, if the featured service is cellular service, the first user may additionally go through one step of picking up a rate plan, one step of acquiring (e.g. buying) a cellular phone, one step of acquiring a SIM card for the acquired cellular phone, one step of having a phone number assigned to the acquired cellular phone, and so on. In another embodiment, the first user signs up only as an “ambassador” of the service provider and not a customer of the service provider, and does not need to go through the aforementioned additional steps which a user signing up as a customer or a “customer and ambassador” of the service provider may need to go through.

After the first user signs up with backend system 102, the first user may use a login form provided by backend system 102 (via the web site of the service provider) to log into backend system 102. FIG. 4B shows an exemplary login form 410. As shown, the first user may enter his/her registered e-mail (used as a registered user name) as well as a registered password, and then click the “Sign In” button 412 to log into backend system 102.

Login form 410 may also be used to let an unregistered user to directly sign-up with and log into backend system 102 in a single step using the user's authentication into a social network platform 103 (such as Facebook, Google Plus or LinkedIn). Specifically, login form 410, as shown, provides a “Facebook login” button 411, clicking of which first directs the user to authenticate into the user's Facebook account and then lets backend system 102 (e.g. sign-up module 212) receive the user's profile information from Facebook (through a token provided by Facebook and calling of Facebook's APIs using the token) and establish an account based on received profile information of the user. Thus, the first user may use login form 410 and “Facebook login” button 411 as an alternative way to sign up with backend system 102.

At block 302, the first user uses one or more UI components provided by the service provider (via a client application) to refer one or more “friends” to the service provider utilizing social media. For the present disclosure, the phrase “referring a user to the service provider” or similar phrases may be used interchangeably with the phrase “referring the featured service (provided by the service provider) to a user” or similar phrases. FIG. 4C is a pictorial illustrating an exemplary UI 420 provided by the service provider (via a client application) so as to enable and/or facilitate the first user to provide referrals utilizing social media. In one embodiment, UI 420 includes a referral instrument 421 and social media integrators 422, 423 and 424.

Referral instrument 421 is an instrument configured to direct a referee to initiate a sign-up process with backend system 102 when activated by the referee and enable backend system 102 to capture information identifying the referrer (which, in this case, is the first user) at the start of the referee's sign-up process (so that backend system 102 may use the captured referrer information to appropriately reward the referrer for the signing-up of the referee). In this embodiment, referral instrument 421 is implemented as a custom created hyperlink 421 pointing to an URL (hereinafter simply referred to as “the referral URL”) which contains information identifying the referrer as well as information indicating or specifying a registration function (as the destination function). In one implementation, the URL is configured in the form of:

Code Snippet 1
http://[base URL]/.../[function identifier]/[referrer identifier]/...

The base URL of the referral URL is the base URL for a host backend server, which, in the case of backend system 102, is the base URL for server 201 (which handles web requests directed to backend system 102 via web server module 211). In on implementation, the function identifier of the referral URL is “reg”, which indication a request for registration from a new user. In one implementation, the referrer identifier of the referral URL is “7910”, which, in this case, is the aforementioned internal identifier of backend system 102 used to uniquely identify the first user. In another implementation, the referrer identifier of the referral URL may be other alphanumerical text so long as the alphanumerical text can be used by backend system 102 to uniquely identify the first user. With this configuration, hyperlink 421, when clicked (activated), results in a new web request sent to server 201 of backend system 102, with the new web request being identified by server 201 as a sign-up request sent by a referee referred by the first user (as identified by the referrer identifier).

A skilled artisan readily appreciates that a referral instrument does not need to be limited to a hyperlink (such as hyperlink 421) pointing to a custom referral URL. A referral instrument may be implemented in various other forms so long as any of those forms of implementation is configured to direct a referee to initiate a sign-up process with backend system 102 when activated by the referee and enable backend system 102 to capture information identifying the referrer at the start of the referee's sign-up process.

Social media integrator 422, 423 and 424 are UI components configured to refer “friends” to the service provider utilizing various forms of social media. For the present disclosure, the term “friend” (of a user) shall be construed broadly to refer to anyone who is related to the user through a social media connection. Examples of a “friend” may include someone who is a “friend” of the user or is related to the user through any kind of defined “relationship” (such as “circle”, “family”, “acquaintance”, “schoolmate”, “classmate”, and so on) in an online social network (such as Facebook) of the user, someone who is a “follower” of the user in an online social microblogging service (such as Tweeter), someone who has once sent an e-mail to the user, someone who has commented on a posting of the user, someone who has responded to a blog of the user, and etc.

At block 303, the first user refers “friends” to the service provider utilizing social media contents generated through activation of one or more clickable icons of social media integrators 422, 423 and 424, with each piece of generated social media content including at least a referral instrument.

Specifically, social media integrators 422 contain clickable icons 422 that enable the first user to refer one or more “friends” who have sent an e-mail to the first user to the service provider. Taking the GMAIL icon 422 as an example, in one implementation, clicking GMAIL icon 422 leads to the first user signing into his/her GMAIL account and letting backend system 102 (via e.g. social media integrator module 213) receive from GOOGLE e-mail addresses of people (users) who have at least once e-mailed the first user (through a token provided by GOOGLE and calling of GMAIL's APIs using the token). Backend system 102 may then cause the client application (which may be a browser or a custom “app”) to pop up, e.g., a dialog box (not shown) listing all the received e-mail addresses and asking the first user to select one or more of those listed e-mail addresses for the referral purpose. After the first user makes the selections and submits the made selections (via, e.g., clicking of a submit button in the dialog box), a custom e-mail created to refer (recommend) the featured service (provided by the service provider) and contain a corresponding referral instrument, is sent to each and every e-mail address selected by the first user.

Clicking other icons 422 of social media integrators 422 (such as the Yahoo! Mail icon 422) also results in a sequence similar to the sequence described above in connection with clicking GMAIL icon 422, enabling a user to select e-mail addresses among e-mail addresses of people who have once e-mailed the first user so that a custom e-mail created to refer (recommend) the featured service and contain a corresponding referral instrument is sent to each and every of those selected e-mail addresses.

Social media integrator 424 is similar to social media integrators 422 in that both social media integrators 424 and 422 are configured to achieve “referral of friends to the service provider” utilizing e-mails as a form of social media. In particular, text box 424 of social media integrator 424 simply lets the first user to input one or more e-mail addresses of “friends” of the first user so that a custom e-mail created to refer the featured service and contain a corresponding referral instrument is sent to each and every e-mail address of those inputted e-mail addresses.

Social media integrators 423 contains clickable icons 423 that enable the first user to refer the featured service to one or more social network “friends” (or “acquaintances”, “schoolmates”, “classmates”, or etc.) or “followers” of the first user. In one implementation, clicking the “Facebook login” button by the first user leads to the first user signing into his/her Facebook (an online social network) account and then backend system 102 (via e.g. social media integrator module 213) posting a custom created status update (news feed) in the Facebook “timeline” or “wall” of the first user (through a token provided by Facebook and calling of Facebook's APIs with the provided token). This posting of the custom created status update in the Facebook “timeline” or “wall” of the first user results in the same status update being posted in the home page of each and every Facebook “friend” of the first user. In one embodiment, before social media integrator module 21 calls Facebook's APIs to post this status update, a referrer user (such as the first user) may be given an opportunity to further customize a pre-created default status update (custom created by the service provider). In one embodiment, the status update is custom created to contain media content (such as text, images or audios) for referring the featured service and include a corresponding referral instrument.

Similarly, clicking the “Tweeter login” button by the first user leads to the first user signing into his/her Tweeter (an online social networking and microblogging service) account and backend system 102 (via e.g. social media integrator module 213) posting a custom created “tweet” to the first user's Tweeter account (through a token provided by Tweeter and calling of Tweeter's APIs with the provided token). This posting of the custom created “tweet” results in all “followers” of the first user receives the same custom created “tweet”. In one implementation, the custom created tweet is custom created to at least include a corresponding referral instrument. The custom created tweet may also contain text provided to refer the featured service if the referral instrument does not use up all the required 140 characters for microblogging.

FIG. 4D is a pictorial illustrating different forms of social media content provided to “friends” of the first user as a result of the first user activating social media integrators 422, 423 and 424. Referring to FIG. 4D, status update 431A is an example of the aforementioned custom created status update posted to the first user's Facebook “timeline” or “wall”. As shown, status update 431A includes text 422A provided to refer the feature service and referral instrument 421A provided to direct a referee to sign up with backend system 102 and enable the backend system to capture information identifying the referrer at the start of the referee's sign-up process. In particular, referral instrument 421A is implemented as hyperlink 421A, which, when clicked, results in a new web request sent to server 201 of backend system 102, with the new web request being identified by server 201 as a sign-up request sent by a referee referred by the first user.

Similarly, tweet 431B is an example of the aforementioned custom created tweet posted to the first user's Tweeter account, and e-mail 431C is an example of the aforementioned custom e-mail sent to each and every e-mail address either selected by the first user or inputted by the first user through social media integrators 422 and 424. As shown, both tweet 431B and e-mail 431C respectively contains text 422B and 422C provided to refer the feature service and respectively includes referral instrument 421B and 422C provided to direct a referee to sign up with backend system 102 and enable the backend system to capture information identifying the referrer at the start of the referee's sign-up process.

A skilled artisan appreciates that social media integrators (UI components) configured to facilitate referral of “friends” to a service provider utilizing various forms of social media, and social media contents custom created for the referral purpose (hereinafter simply referred to as “referral social media contents”), may not be limited to what have been exemplified in FIG. 4C and FIG. 4D. Social media integrators other than social media integrators 422, 423 and 424 may be provided to produce ensuing referral social media contents. For example, social media integrators configured to lead to posting of custom created messages to one or more instant messaging platforms (via social media integrator module 213 of backend system 102) may be provided. Similarly, referral social media contents may be implemented in forms different from status update 431A, tweet 431B and e-mail 431C. For example, a piece of referral social media content may be implemented in the form of an SMS including referral text and a corresponding referral instrument.

At block 304, a second user uses the referral instrument included in a piece of generated referral social medial content to sign up with backend system 102, resulting in information identifying the first user as the referrer being captured at the start of the sign-up process.

Specifically, a second user, upon receiving and viewing a referral social media content piece, decides to sign up with the service provider. Since a referral instrument is present in the referral social media content piece, the second user may conveniently activate the referral instrument. In one embodiment, a referral instrument 421 (such as referral instrument 421A or 421C) is provided in the form of a hyperlink 421 (such as hyperlink 421A or 421C) pointing to the aforementioned referral URL configured in accordance with code snippet 1. Thus, the second user may activate referral instrument 421 by clicking hyperlink 421, resulting in a new web request sent to server 201 of backend system 102, with the new web request identified by server 201 as a sign-up request sent by a referee referred by the first user.

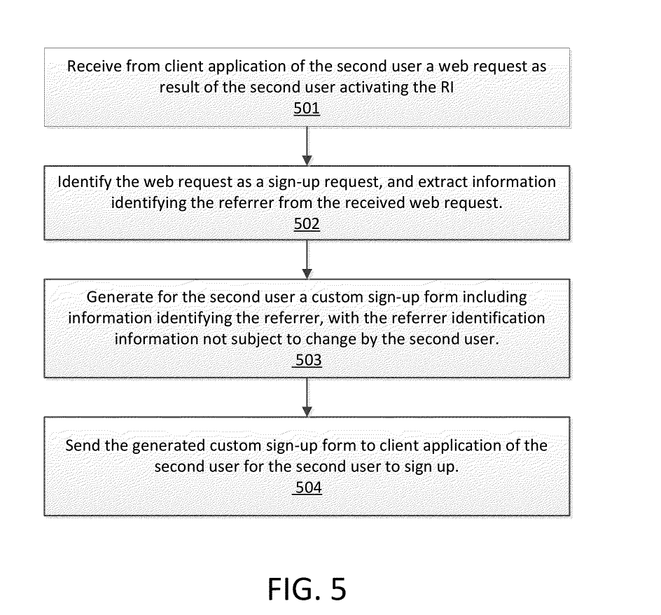

FIG. 5 is a flowchart illustrating an exemplary implementation of block 304 from the perspective of backend system 102, according to one or more embodiments of the present disclosure. At sub-block 501, server 201 of backend system 102 receives a web request from a client application operated by the second user as a result of the second user clicking hyperlink 421 (displayed by the client application).

At sub-block 502, from the aforementioned function identifier “reg” (received as part of the web request), server 201 identifies the web request as a sign-up request resulting from clicking a hyperlink pointing to a referral URL. Thus, from the received web request, server 201 additionally extracts the aforementioned referrer identifier “7910” as an internal identifier that can be used to uniquely identify the referrer.

At sub-block 503, server 201 generates (via e.g., GUI modules 217), specifically for the second user, a custom sign-up form including information identifying the referrer, with the referrer identification information not subject to change by the second user. FIG. 4E is a pictorial illustrating an exemplary custom sign-up form 400B which server 201 generates for the second user. Sign-up form 400B is very similar to sign-up form 400A shown in FIG. 4A, except that the “referral e-mail” field 401B is pre-filled with the e-mail address of the first user, and is “grayed” so that the second user cannot change the pre-filled content of the “referral e-mail” field. The “referral e-mail” field is a field used to identify the referrer (which, in this case, is the first user).

In generating custom sign-up form 400B, server 201 uses the aforementioned referrer identifier “7910” to identify the referrer (via, e.g., one or more business logic modules 218) and retrieve the unique e-mail address of referrer based on the identifier. Once the e-mail address of referrer becomes available, server 201 may create custom sign-up form 400B for the second user. In creating custom sign-up form 400B, server 201 specifically renders the “referral e-mail” field “grayed” and unchangeable, thus ensuring that the referrer information would be preserved throughout the second user's sign-up process. In another implementation, the “referral e-mail” field may be included in custom sign-up form 400B as a hidden field in ensuring that the referrer information would be preserved during the second user's sign-up process. As a skilled artisan appreciates, other implementations may be used to preserve the referrer information during the second user's sign-up process without departing from the spirit and the scope of the present disclosure.

At sub-block 504, server 201 sends the generated custom sign-up form to the client application (such as a browser) for display so as to enable the second user to sign up with the service provider.

If the client application is a non-browser custom application, at sub-block 503, server 201, instead of generating a full-blown custom sign-up form 400B, may generate a command designed to instruct the client application to implement and display the same custom sign-up form 400B (or any other custom sign-up form designed to achieve the same effect). Then, at sub-block 504, server 201 sends the generated command, as opposed to a full-blown sign-up form, to the client application so as to achieve the display of the same custom sign-up form 400B (or any other custom sign-up form designed to achieve the same effect).

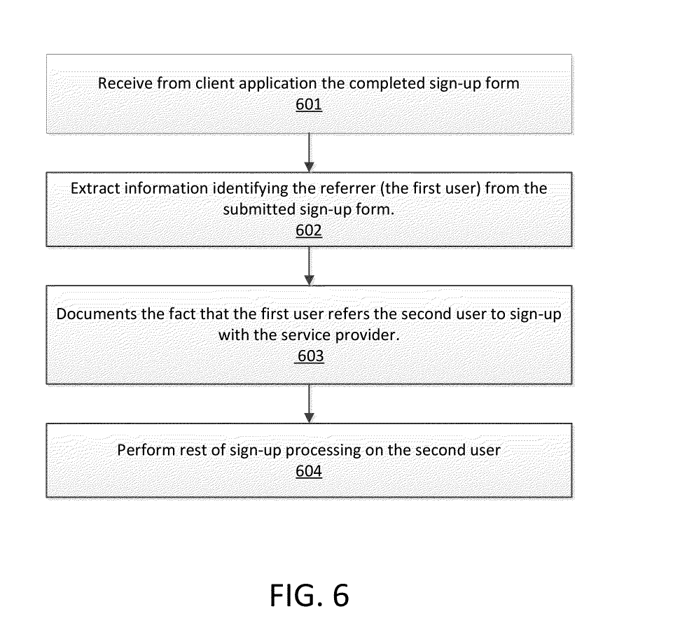

Returning to the process illustrated in FIG. 3, at block 305, backend system, in processing the sign-up of the second user, documents a referral of the second user in the account of the first user. FIG. 6 is a flowchart illustrating exemplary implementations of block 305 from the perspective of backend system 102, according to one or more embodiments of the present disclosure. At sub-block 601, after the second user submits the completed custom sign-up form 400B, server 201 receives from the client application the submitted sign-up form with filled-in form data. To server 201, submission of a completed sign-up form represents a request for signing up with backend system 102. Thus, upon receiving the form data of the completed sign-up form (via, e.g. web server module 211), server 201 may perform processing for a sign-up request (via, e.g. user sign-up module 212).

At sub-block 602, as a part of the sign-up processing, server 201 checks from the received form data to see if the field identifying a referrer, such as the “referral e-mail” field, is filled or empty. As noted above, in custom sign-up form 400B, the “referral e-mail” field is pre-filled with the first user's e-mail address and cannot be changed. As a result, server 201 notes that the “referral e-mail” field is not empty, and thus proceeds to extract information identifying the referrer (which, in this example, is the e-mail address identifying the referrer) from the received form data.

At sub-block 603, upon retrieving the identification information of the referrer (which, in this case, is the first user), server 201 uses the identification information to identify the first user as the referrer (via, e.g., one or more business logic modules 218). Then, server 201 documents the fact that the first user refers the second user to sign-up with the service provider (via, e.g., one or more business logic modules 218). In one implementation, server 201 adds the second user to “friends circle” of the first user under the first user's account, as stored in DS 202. In this implementation, “friends circle” of a user is a collection of referee users referred by the user stored in DS 202 as part of the user's account information.

At sub-block 604, server 201 performs the rest of the sign-up processing on the second user. Sub-block 604 may be performed before, after or concurrently with any of sub-blocks 602 and 603.

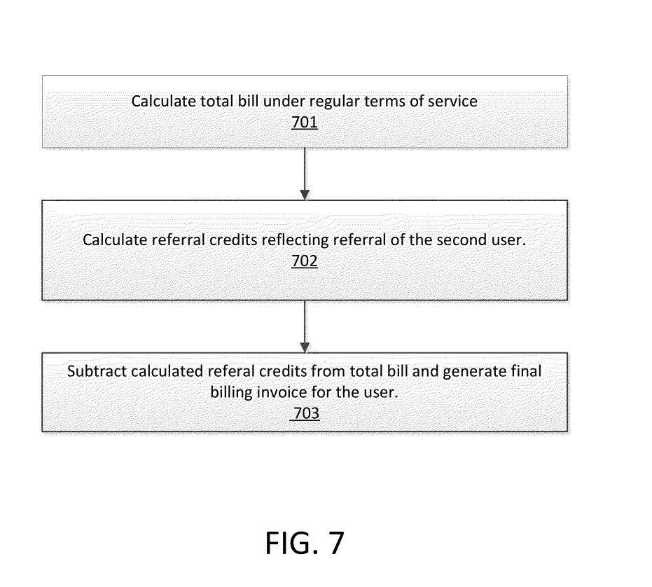

Returning to the main process illustrated in FIG. 3, at block 306, billing module 214 of backend system 102 automatically incorporates referral credit corresponding to the referral of the second user in the bill of the first user (when, e.g., the second user ends up subscribing to the featured service). FIG. 7 is a flowchart illustrating exemplary implementations of block 306 from the perspective of billing module 214, according to one or more embodiments of the present disclosure. At sub-block 701, billing module 214 calculates a total bill of the first user under regular terms of service. Thus, in one embodiment, if the first user is only signed up as an ambassador, the total bill may be zero. If the first user is signed up as a customer, the total bill of the user may be billed based on, e.g. the air time used by the first user and the rate plan signed up by the first user if the featured service is cellular service.

At sub-block 702, billing module 214 calculates referral credits resulting from the first user's referrals of other registered users (including the second user). In one embodiment, a referral credit can only be realized under certain conditions. For example, a referral credit can only be realized when a referee becomes a paying customer of the service provider and can stay realized so long as the referee remains to be a paying customer. Thus, to calculate total amount of referral credits, billing module 214 retrieves (from DS 202) data documenting referrals achieved by the first user. The retrieved referral data may include registered users who are referred by the first user (including the second user) as well as the subscription status of the referred registered users.

For each referred user, billing module 214 adds a corresponding referral credit (such as $5) to the total amount of referral credits of the first user when the status of the referred user meets a pre-set condition for realizing a corresponding amount of referral credits. After billing module 214 iterates through all of the referred users of the first user, a total amount of referral credit of the first user is calculated. Since the second user is included in the referred users of the first user, a corresponding referral credit resulting from referral of the second user is reflected in the total amount of referral credits of the first user when the status of the second user meets the pre-set condition.

At sub-block 703, for the first user, billing module 214 subtracts the total amount of referral credits from the total bill and generates a final bill for the first user. Once a final bill is determined by billing module 214, backend system 102 may invoke invoicing module 215 to invoice the first user accordingly. In one embodiment, step 306 (or, in other words, sub-blocks 701 to 703) may be executed by a pre-scheduled cron job (or equivalent) via cron job modules 216.

In one embodiment, billing module 214 may produce a standard summary bill (for a user) listing the total amount of referral credits and the summary basis thereof. FIG. 4F is such an exemplary summary bill for the user. Additionally, billing module 214, or another application module, may be invoked to provide more detailed information about bases of user's referral credits. FIG. 4G shows a UI provided by backend system 102 to show a total amount of referral credits and detailed information about bases of the user's referral credits. Specifically, upon receiving the user's request for the UI, backend system 102 retrieves detailed information about “friends circle” of the user (which, in one embodiment, includes the status of each and every “friend” of the “friends circle” of the user), calculates the total amount of referral credits (via, e.g., billing system 214) using the retrieved “friends circle” information, and generate the UI using the retrieved the retrieved “friends circle” information and the calculated total referral credit (via one or more GUI modules 217). Then, backend system 102 provides the generated UI to the client application so that the client application visually displays the total amount of referral credits as well as the status of each and every “friend” of the “friends circle” of the user.

Accordingly, the present disclosure provides a system and method that combines and integrates an aspect of leveraging social media to facilitate a user to acquire new customers with an aspect of automating billing reflecting rewards for customer acquisition to motivate a user to engage in customer acquisition activities. This combination and integration effectively increase the efficiency of using existing registered users to acquire new customers, thereby helping a service provider to effectively reduce cost which otherwise would be forced to incur in expanding and growing the service provider's underlying business.

While the disclosure has been described with reference to exemplary embodiments, it will be understood by those skilled in the art, and it is clearly demonstrated through the second embodiment, that various changes may be made and equivalents may be substituted for elements thereof without departing from the scope of the disclosure. In addition, many modifications may be made to adapt a particular system, device or component thereof to the teachings of the disclosure without departing from the essential scope thereof.

Therefore, it is intended that the disclosure not be limited to the particular embodiments disclosed for carrying out this disclosure, but that the disclosure will include all embodiments falling within the scope of the appended claims.

What is claimed is:

1. A method of acquiring new customers leveraging social media, the method comprising the steps of:
a first user activating a UI component such that a custom-created content is disseminated to a social media platform, the custom-created content containing content referring a featured service of a service provider and a referral instrument;
a second user activating the referral instrument via the social media platform, the activation of the referral instrument directing the second user to initiate a sign-up process with a backend system of the service provider and enable the backend system to capture information identifying the first user as a referrer at the start of the referee's sign-up process; and
the backend system providing referral credit to the first user.
